(19) United States
(12) Patent Application Publication
(10) Pub. No.: US 2026/0315938 A1
(43) Pub. Date: Oct. 15, 2026

(54) SYSTEM, METHOD, AND MULTI-FUNCTIONAL INPUT DEVICE FOR PROCESSING SOUND DATA

(71) Applicant: Aaron Dufala, Amherst, OH (US)

(72) Inventor: Aaron Dufala, Amherst, OH (US)

(21) Appl. No.: 19/179,963

(22) Filed: Apr. 15, 2025

(51) Int. Cl. A63F 13/814; A63F 13/22; A63F 13/245; A63F 13/54; A63F 13/98

(52) U.S. Cl. CPC A63F 13/814; A63F 13/22; A63F 13/245; A63F 13/54; A63F 13/98

(57) ABSTRACT

A system, method, and multi-functional input device for processing sound data. The disclosure includes various input devices with one or more processors capable of processing input signals for use by either a video game console or a system capable of processing audio data. The disclosure further includes a system and method of using a guitar-simulating video game controller to produce input signals readable by a system capable of processing data from the controller.

### BACKGROUND OF THE INVENTION

Field of the Invention. This invention relates generally to input devices, and more particularly to multi-functional input devices adapted for processing sound data for use in video games and for use in producing sound.

In the current digital age, traditional mechanical apparatuses are being replicated through electronic means. For example, video games like Rock Band and Guitar Hero utilize electronic instrument-simulating controllers to provide inputs. Further examples include input devices that can send readable data to external software, thereby producing musical sound, and instrument replicas that electronically produce sound.

Some of these devices are very similar. A guitar-simulating controller is used in video games, and a guitar-simulating device is used to produce its own sound. However, these devices are configured to produce a single output. Thus, users interested in playing instrument-based video games and also producing sound from a standalone electronic device or synthesizing sound with software must purchase multiple input devices.

One solution exists in the prior art, which is modification of an existing input device. The input processor of some devices can be reprogrammed to accommodate different outputs. However, this solution requires a user to purchase replacement parts and/or have expertise in disassembling and reconstructing the input devices. Furthermore, if the input device processor can only store one output program, this inconvenient process must be repeated.

### BRIEF SUMMARY OF THE INVENTION

This invention is a multi-functional input device and a system and method of processing audio data. The multi-functional input device generally comprises body, one or more input mechanisms housed within the body and able to be engaged by a user, at least one processor housed within the body, a means for connecting one or more input mechanisms to the processor, and a means for connecting the processor to an external device. The processor or processors are able to process input signals for use by either a video game console or a system capable of processing audio data.

A user can connect the multi-functional input device to a video game console and play a video game normally. Then, a user can connect the same input device to an external system or software, without making any changes to the device, and engage the same input mechanisms to produce or synthesize sound.

In various embodiments, the input device has a single processor capable of processing input signals for use by either a video game console or by external software.

In some embodiments, the input device includes two processors, each processor being configured to process input signals for use by either a video game console or external software.

The system and method of processing audio data generally comprises using a guitar-simulating video game controller capable of sending input signals using a protocol readable by a system capable of processing audio data, connecting the controller to an external system or device capable of processing data from the controller, and engaging the input mechanisms. A user can connect a guitar-simulating video game controller to an external system or device and engage the controller as usual, thereby producing or synthesizing sound.

### BRIEF DESCRIPTION OF THE DRAWINGS

FIG. 1 is a front elevation view of an embodiment of a multi-functional input device.

FIG. 2 is a rear elevation view of an embodiment of a multi-functional input device.

FIG. 3 is a front elevation view of an embodiment of a multi-functional input device with the front housing removed.

FIG. 4 is a side perspective view of an embodiment of a multi-functional input device with the front housing removed.

FIG. 5 is a side perspective view of an embodiment of a multi-functional input device connected to a computer.

FIG. 6 is a partial front view of a means for producing sound from an embodiment of a multi-functional input device.

FIG. 7 is a partial side perspective view of a means for producing sound from an embodiment of a multi-functional input device.

FIG. 8 is an exploded view of an embodiment of the input mechanisms housed in the neck of a multi-functional input device.

FIG. 9 is an exploded view of an embodiment of the input mechanisms housed in the neck of a multi-functional input device.

FIG. 10 is a partial side perspective view of a whammy input mechanism of an embodiment of a multi-functional input device.

FIG. 11 is a side perspective view of a strum input mechanism of an embodiment of a multi-functional input device.

FIG. 12 is a partial front perspective view of a start/select input mechanism of an embodiment of a multi-functional input device.

FIG. 13 is a flowchart illustrating a method for processing multiple inputs for a multi-functional input device, according to one or more embodiments of the disclosure.

FIG. 14 is a flowchart illustrating a method for processing a signal input for a multi-functional input device, according to one or more embodiments of the disclosure.

FIG. 15 is a side perspective view of a multi-functional input device, according to one or more embodiments of the disclosure.

FIG. 16 is a side perspective view of a multi-functional input device, according to one or more embodiments of the disclosure.

### DETAILED DESCRIPTION OF THE INVENTION

This invention is a multi-functional input device and a system and method of processing audio data. The multi-functional input device generally comprises body, one or more input mechanisms housed within the body and able to be engaged by a user, at least one processor housed within the body, a means for connecting one or more input mechanisms to the processor, and a means for connecting the processor to an external device. The processor or processors are able to process input signals for use by either a video game console or a system capable of processing audio data.

For purposes of this disclosure, “video game console” means any computing device or system that processes video games, including but not limited to consoles (e.g., Xbox, PlayStation etc.), computers, laptops, and mobile phones.

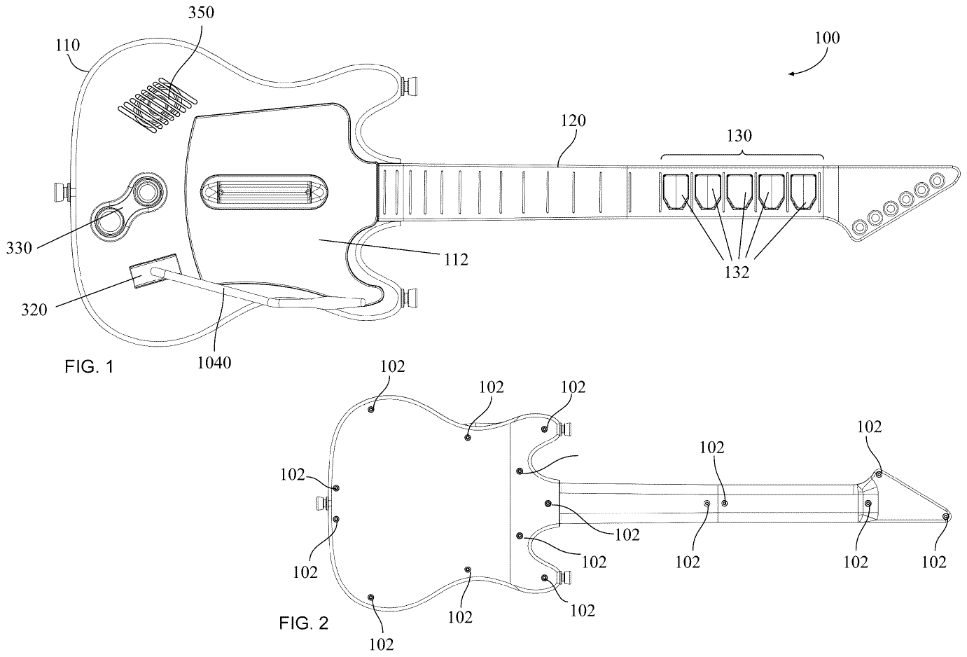

Referring now to FIG. 1 of the drawings, a preferred embodiment of a multi-functional input device 100 is shown, generally comprising a body 110, one or more input mechanisms, one or more processors (not shown), and a means for connecting the processor to an external device.

In a preferred embodiment, the body 110 is shaped like a guitar. This embodiment further comprises a neck 120 connected to and extending outwardly from the body 110. The neck 120 houses one or more input mechanisms 130. Each input mechanism is able to be engaged by a user. Examples of input mechanisms include push buttons 132, a whammy input mechanism 320, and start/select button input mechanism 330. In the preferred embodiment, the push buttons 132 simulate guitar frets. The whammy input mechanism 320 and start/select button input mechanism 330 are housed in the body 110, if applicable.

In various embodiments, the body 110 includes magnetic attachment system 112 configured to magnetically attach materials having magnetic properties. Non-limiting examples of the materials include ferromagnetic materials, such as steel, iron, nickel, and cobalt. The magnetic attachment system 112 may include one or more permanent magnets. Non-limiting examples of permanent magnets include neodymium, samarium cobalt, alnico, and ferrite.

The body 110 houses one or more processors. Each processor is able to process input signals for use by either a video game console or a system capable of processing audio data. Each processor is able to process input signals for use by an external program or device.

In various embodiments, the processor can detect the type of external program and process input signals accordingly. Examples of external programs include Examples of external programs include digital audio workstations (DAWs), MIDI sequencers, virtual instrument plugins (VSTs), sound synthesis software, music notation programs, video games, multimedia applications, simulation software, and other interactive, audio, or MIDI processing applications executed on gaming consoles, personal computers, or other computing devices.

In further embodiments, the processor can be manually toggled between processing inputs for use by a video game console and processing inputs for use by a system capable of processing audio data. The processor may be toggled by actuating a switch on the input device 100 or by configuring the processor.

In further embodiments, the processor can process and output multiple signal types in a simultaneous or near-simultaneous manner, including both Human Interface Device (HID) and Musical Instrument Digital Interface (MIDI) signals. This allows the processor to function appropriately when connected to either a video game console or a system capable of processing audio data without the need for toggling configurations.

In further embodiments, the multi-level input device includes two processors housed within the body 110. The second processor is connected to one or more input mechanisms. The first processor is configured to process input signals for use either by a video game console or by a system capable of processing audio data but not both. The second processor is configured to process input signals for use by either a video game console or by a system capable of processing audio data but not for the same purpose as the first processor.

The multi-functional input device 100 further includes a means for connecting one or more input mechanisms to the processors. The means for connecting the input mechanisms to the processors may be accomplished by any suitable means, such as electrical connectors.

In various embodiments, the means for connecting the input mechanisms to the processor is a novel electrical connector that provides an additional and detachable attachment point between the connected components. The additional attachment point permits users to detach replace components of the input device 100 without the need for soldering or other mechanical skills.

The multi-functional input device 100 further includes a means for connecting the processor to an external device remotely or by direct connection. The means for connecting the processor to an external device may be accomplished by a USB or other connective cable, Wi-Fi connection, Bluetooth connection, or any other suitable means.

In further embodiments, the multi-functional input device 100 includes a means for producing sound directly from the multi-functional input device 100, where the means for producing sound is housed within the body 110. The means for producing sound may be accomplished by one or more speakers 350 configured to produce sound waves (i.e., system sounds, alerts, other audio sounds).

Referring now to FIG. 2 of the drawings, the rear side of a preferred embodiment of a multi-functional input device 100 is shown. In this embodiment, fasteners 102 are used to hold together the body 110 and neck 120 of the multi-functional input device 100. Fasteners 102 may include screws, pins, nails, clips, adhesive, or any suitable means.

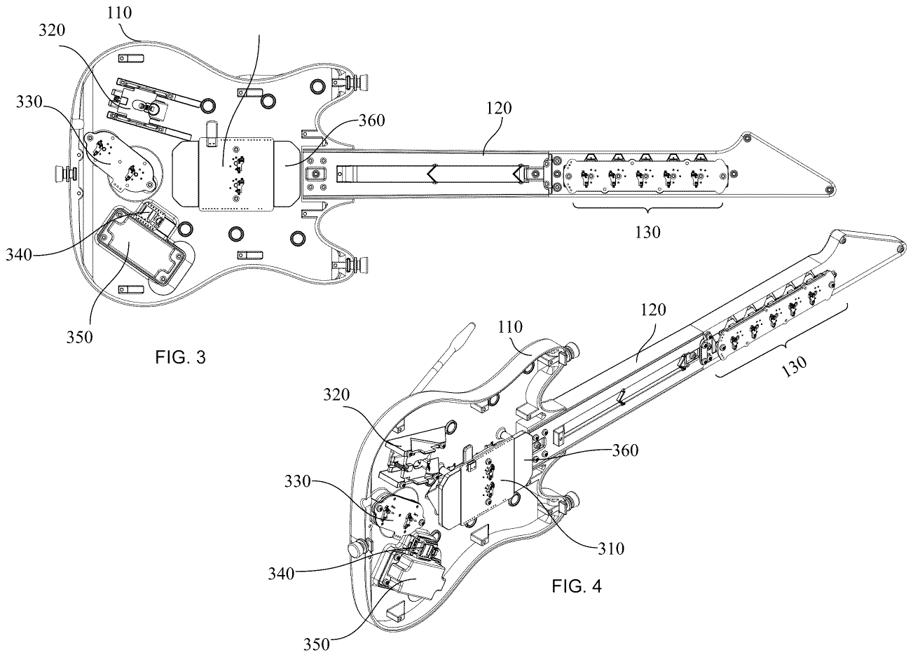

Referring now to FIGS. 3 and 4 of the drawings, an internal view of a preferred embodiment of a multi-functional input device 100 is shown. This embodiment includes a processor 310, a whammy input mechanism 320, start/select button input mechanism 330, an audio-processing microcontroller 340, internal speakers 350, and a strum subsystem 360. In the illustrative embodiments, the processor 310 is a primary control PCB.

The strum subsystem 360 is a structural and modular input interface for the processor 310.

The processor 310 is a central circuit board within the multi-functional input device 100 responsible for managing and coordinating the operations of all other components within the multi-functional input device 100 by directing signal flow, power distribution, and data communication, essentially acting as the “brain” of the multi-functional input device 100, ensuring its smooth and intended functionality. The processor 310 may include power regulation circuitry, wired or wireless communication interface, GPIO connections, firmware storage (e.g., EEPROM/Flash and/or similar non-volatile memory).

The audio-processing microcontroller 340 is electrically connected to the processor 310 and the internal speakers 350. The audio-processing microcontroller 340 is configured to manipulate and process digital audio signals, performing functions like filtering, mixing, equalization, and other sound adjustments by executing programmed algorithms on incoming audio data, ultimately controlling the output sound quality through the internal speakers 350. Non-limiting examples of audio-processing microcontrollers 340 include Digital Signal Processing (DSP), Analog to Digital Conversion (ADC), and Digital to Analog Conversion (DAC).

The internal speakers 350 are configured to produce sound waves (i.e., system sounds, alerts, other audio sounds) based on the electrical input signals received from the audio-processing microcontroller 340.

The whammy input mechanism 320 is a dynamic input and control mechanism that receives user input caused by a user moving the user-actuated input lever.

The start/select button input mechanism 330 is configured to receive a user's input when a user engages the start/select button input mechanism 330. The start/select button input mechanism 330 is detachably attached to the processor, such as the primary control PCB 310.

As shown in FIGS. 3 and 4, the neck 120 houses input mechanisms that are configured to be engaged by a user. The input mechanisms 130 are electrically connected to the processor 310. In some embodiments, the input mechanisms are attached to the processor by means other than soldering, for example, making the connective wires with intermediate and detachable connection points, such as plugs.

In further embodiments, the multi-functional input device 100 further includes a guitar strum-simulating button input mechanism housed within the body 110. The guitar strum-simulating button input mechanism is electrically attached to the processor 310.

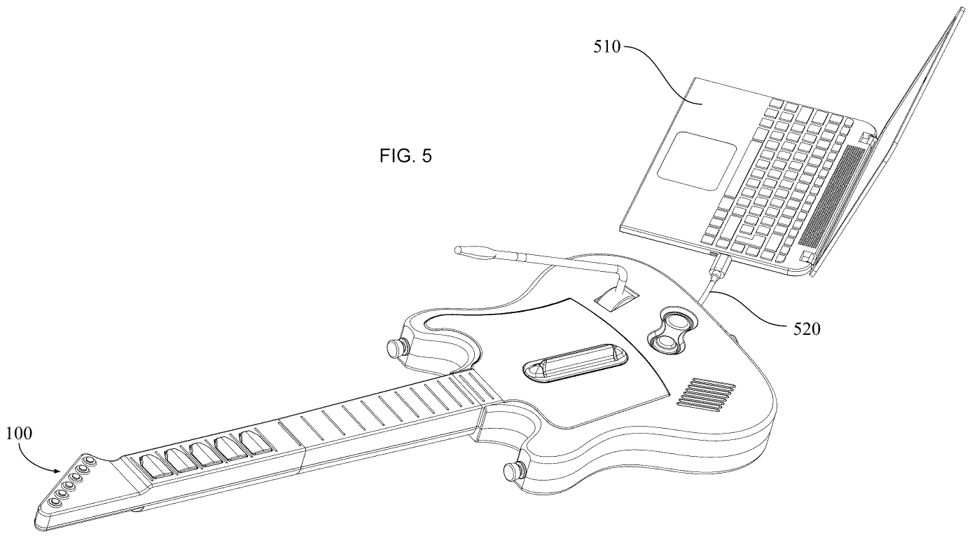

Referring now to FIG. 5 of the drawings, an embodiment of a multi-functional input device 100 is shown connected to an external device 510 via a USB cable 520. The USB cable 520 is configured for communication and data transfer between the multi-functional input device 100 and the external device 510. The USB cable 520 may optionally be configured for power transfer from the external device 510 to the multi-functional input device 100.

In various embodiments, the multi-functional input device 100 and the external device 510 may be wirelessly connected via wireless technologies. Non-limiting examples of wireless technologies include Bluetooth, Wi-Fi, Infrared, Wireless USB, or any other suitable means.

The external device 510 may be any device capable of processing audio data. Non-limiting examples of external devices 510 may include a communication and/or computing device, such as a mobile phone (e.g., a smart phone, a radiotelephone, and/or the like), a computer (e.g., a laptop computer, a tablet computer, a handheld computer, and/or the like), a gaming device, a wearable communication device (e.g., a smart wristwatch, a pair of smart eyeglasses, and/or the like), an external synthesizer (e.g., a hardware or software-based instrument), or a similar type of device.

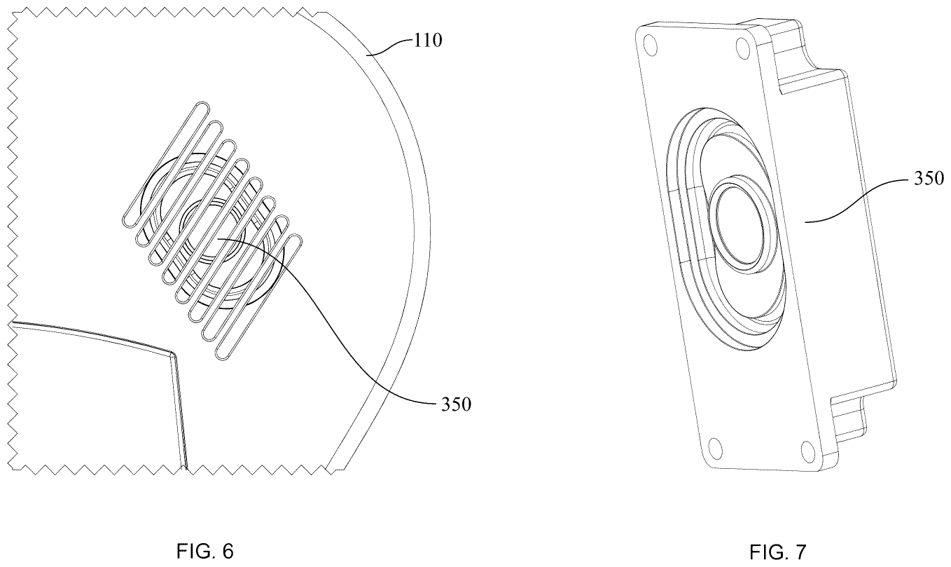

Referring now to FIGS. 6 and 7 of the drawings, an embodiment of an internal speaker 350 for use by a multi-functional input device 100 is shown. The internal speaker 350 is housed within the body 110 of the multi-functional input device 100.

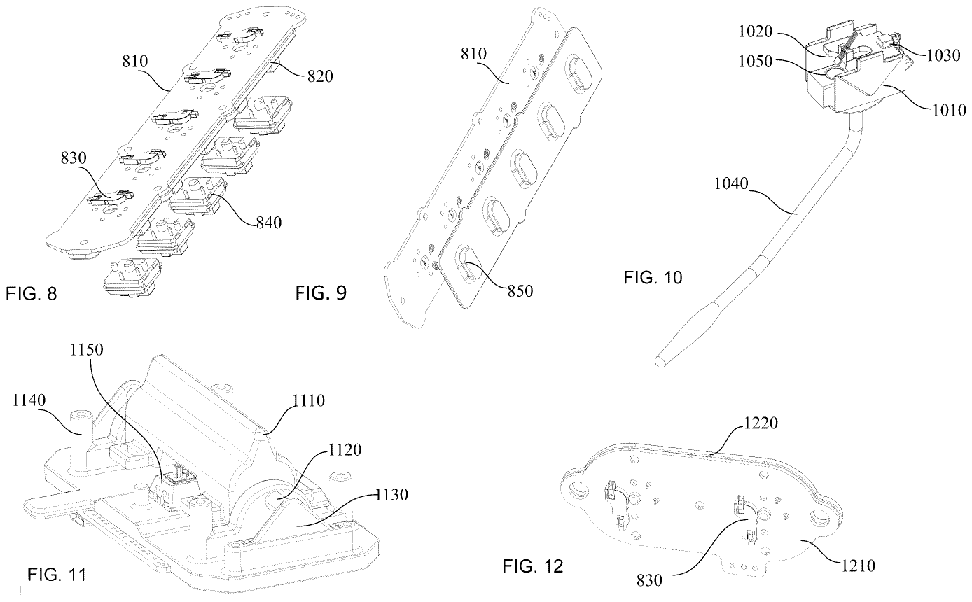

Referring now to FIGS. 8 and 9 of the drawings, an embodiment of the input mechanisms 130 housed in the neck 120 of the multi-functional input device 100 is shown. In a preferred embodiment, the input mechanism 130 is a fret subsystem that may include a fret input PCB 810, a fret-subsystem PCB mounting system 820, a hot-swap function 830, one or more user input mechanisms (i.e., mechanical or silicone switches 840), an embedded silicone or rubber noise-dampening insert, and silicon switch pads 850. Non-limiting examples of user input mechanisms include push buttons, directional controls (e.g., directional pad or D-pad, joystick, and/or similar navigation inputs), and mechanical or silicone switches (i.e., hot-swappable options).

The fret input PCB 810 electrically connects the fret subsystem to the processor 310. The fret-subsystem PCB mounting system 820 is configured to physically connect the fret subsystem to the processor 310 or the strum subsystem 360.

Referring now to FIG. 10 of the drawings, an embodiment of a whammy input mechanism 320 of the multi-functional input device 100 is shown. The whammy input mechanism 320 is a dynamic input and control mechanism that receives user input caused by a user moving the user-actuated input lever 1040. The whammy input mechanism 320 may include a user-actuated input lever 1040 (e.g., whammy bar, modulation arm, pivoting control handle), a mounting swivel bracket 1010, a rotary position sensor 1020, a spring-loaded return mechanism 1030, and a magnet 1050. The mounting swivel bracket 1010 allows the user-actuated input level 1040 to swivel or rotate as a result of the force applied by the user. The rotary position sensor 1020 detects the position of the user-actuated input lever 1040. The spring-loaded return mechanism 1030 reverts the user-actuated input lever 1040 to its original position when not under a force applied by the user. The whammy input mechanism 320 is detachably attached to the processor, such as the primary control PCB 310.

Referring now to FIG. 11 of the drawings, an embodiment of a strum subsystem 360 of the multi-functional input device 100 is shown. The strum subsystem 360 may include a strum bar 1110, swivel rod 1120, a rod locking mechanism 1130, mounting bracket 1140, user input mechanism 1150, and hot-swap function 830. Non-limiting examples of user input mechanisms include mechanical switches (i.e., hot-swappable options).

The mounting bracket 1140 secures the processor 310 and input mechanisms. The rod locking mechanism 1130 locks the swivel rod 1120 into a set position.

Referring now to FIG. 12 of the drawings, an embodiment of the start/select button input mechanism 330 of the multi-functional input device 100 is shown. The start/select button input mechanism 330 is configured to receive a user's input when a user engages the start/select button input mechanism 330.

The start/select button input mechanism 330 may include a start/select input PCB 1210, a PCB mounting system 1120, one or more user input mechanisms, and a hot-swap function 830. Non-limiting examples of user input mechanisms include push buttons, directional controls (e.g., directional pad or D-pad, joystick, and/or similar navigation inputs), and mechanical or silicone switches (i.e., hot-swappable options), knobs, encoders, and touch sensors.

The start/select input PCB 1210 electrically connects the start/select button input mechanism 330 to the processor 310. The PCB mounting system 1120 is configured to physically connect the start/select button input mechanism 330 to the processor 310 or the strum subsystem 360.

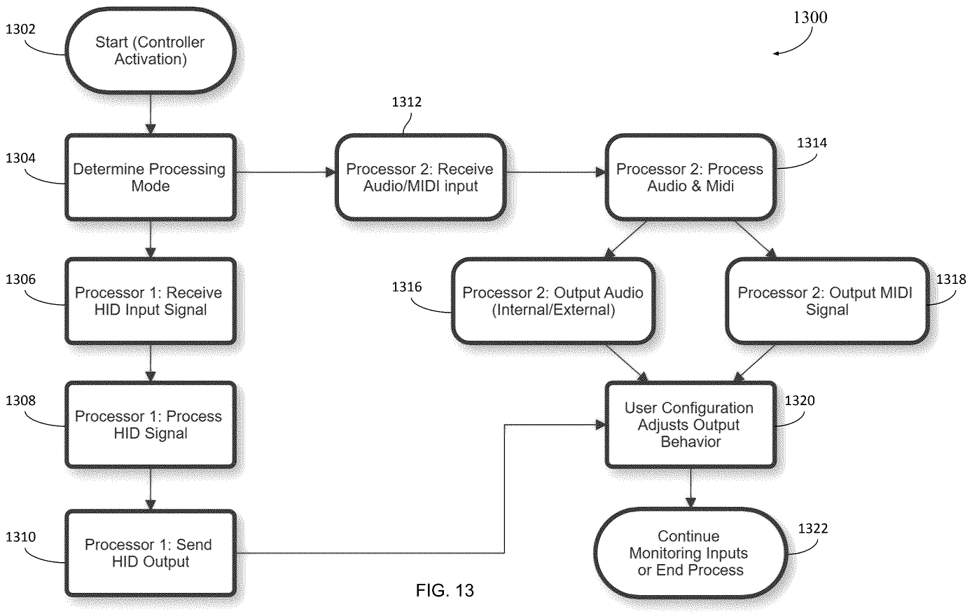

Referring now to FIG. 13 of the drawings, a flowchart showing a method for monitoring multiple inputs for a multi-functional input device 100 according to one or more embodiments of the disclosure is provided. The method 1300 starts by activating a controller (i.e., the multi-functional input device 100) in Step 1302. Next, in Step 1304, the processing mode is determined based on the input signal. The input signal may be a Human Interface Device (HID) input signal, a Musical Instrument Digital Interface (MIDI) input signal, an external audio input signal, a loaded sound file (e.g., a locally stored WAV file or cloud-based audio file), a synthesized sound signal, or any combination thereof. Depending on the selected mode, the device may generate or manipulate sound data and produce an audio output signal through an internal speaker, TRS output, or other connected system.

If the input signal is a HID input signal, then one or more processors receive the HID input signal in Step 1306. The HID input signal is processed in Step 1308 and then transmitted as an HID output signal in Step 1310.

If the input source is an external audio input signal, a loaded sound file, a synthesized sound signal, a MIDI input signal, or any combination thereof(referred to as an Audio/MIDI input signal), then one or more processors receive and process the signal(s) in Step 1312 and Step 1314. Depending on the selected mode, the processed signals may be output in Step 1316 as an audio output signal (e.g., via speakers, TRS, or another output method) and/or in Step 1318 as a MIDI output signal for external control.

Next, in Step 1320, the user configuration adjusts the output behavior based on the signals from the HID output signal of Step 1310, the audio signal of Step 1316, and the MIDI signal of Step 1318. While FIG. 13 illustrates these outputs, additional signal outputs, such as synthesized or sampled audio, may also be present depending on the selected processing mode. After the user configuration has been adjusted, the method 1300 either continues or ends in Step 1322. The method 1300 continues by reverting back to Step 1302.

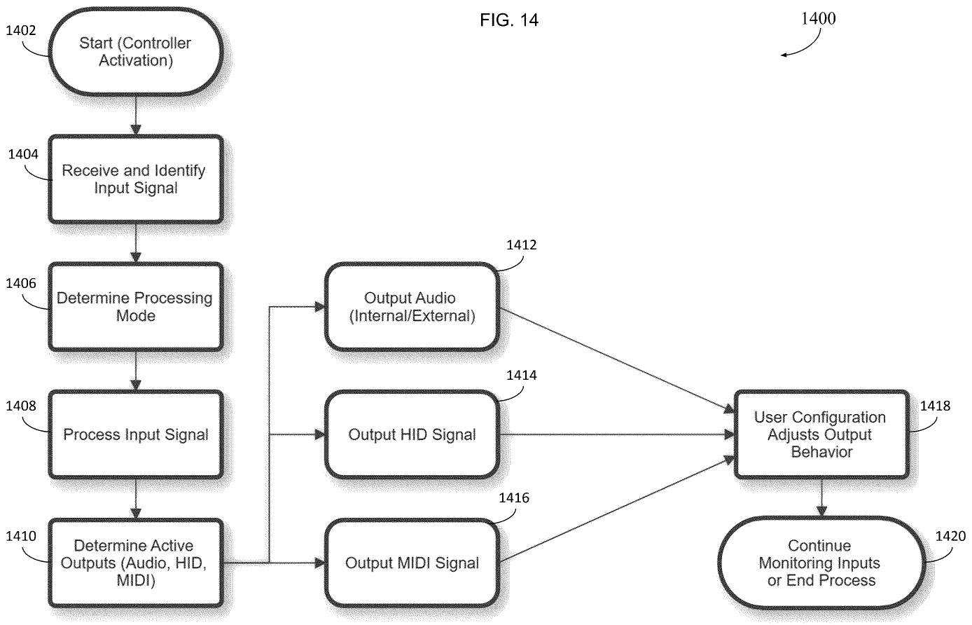

Referring now to FIG. 14 of the drawings, a flowchart showing a method for monitoring a signal input for a multi-functional input device 100, according to one or more embodiments of the disclosure is provided. The method 1400 starts by activating a controller (i.e., the multi-functional input device 100) in Step 1402. The multi-functional input device 100 receives and identifies an input signal in Step 1404, determines the processing mode in Step 1406 based on the input signal, and then processes the input signal in Step 1408. After processing, the device determines the active output signals in Step 1410. The active output signals may include an audio output signal (Step 1412), a synthesized sound output signal, a sampled audio output signal, an HID output signal (Step 1414), and a MIDI output signal (Step 1416).

Next, in Step 1418, the user configuration adjusts the output behavior based on the signals from the audio output signal, synthesized sound output signal, sampled audio output signal, HID output signal, and MIDI output signal. After the user configuration has been adjusted, the method 1400 either continues or ends in Step 1420. The method 1400 continues by reverting back to Step 1404.

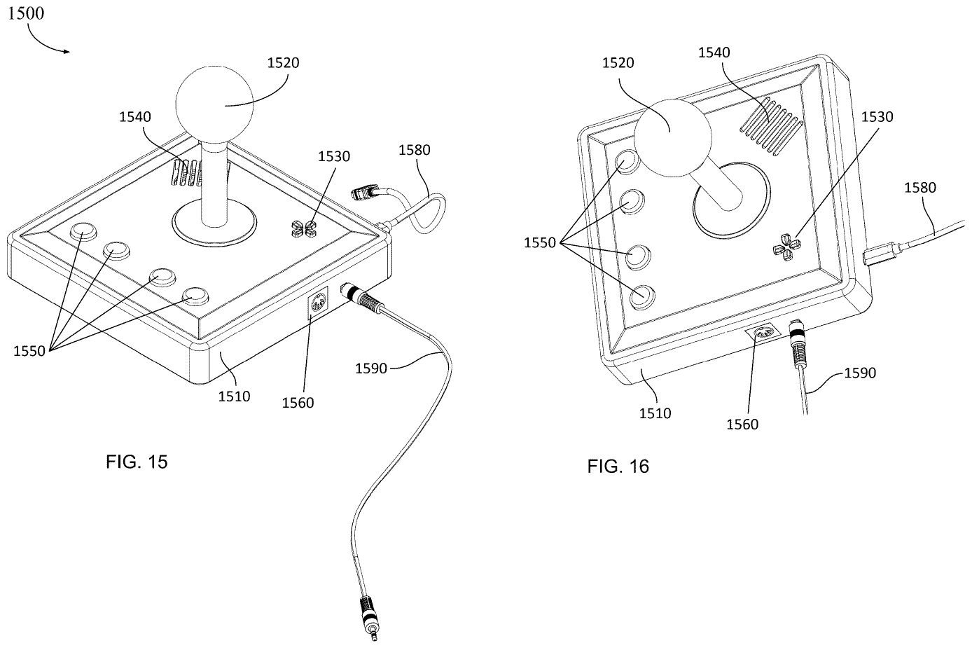

Referring now to FIGS. 15 and 16 of the drawings, an alternative embodiment of a multi-functional input device 1500 is shown. The multi-functional input device 1500 includes a case 1510, a directional joystick 1520, a directional pad 1530, an audio device 1540, a plurality of buttons 1550, and a plurality of ports 1560. The case 1510 houses one or more processors, the audio device 1540.

The directional joystick 1520 and the directional pad 1530 are operated by a user by moving the directional joystick 1520 into a specific direction or pressing a specific direction on the directional pad 1530. Based on the movement of the directional joystick 1520 or the directional pad 1530, this movement is converted into an electric signal that is processed by the processor housed within the case 1510.

The audio device 1540 is configured to produce a sound. The audio device 1540 may include one or more audio speakers.

The plurality of buttons 1550 are configured to receive user input by the user pressing the buttons 1550. By the user pressing one or more buttons 1550, the buttons 1550 interact with one or more processors by transmitting an electrical signal to the processor(s).

The plurality of ports 1560 are configured to transmit and receive data and to supply power to the multi-functional input device 1500. A data cable 1580 and audio cable 1590 may connect to the multi-functional input device 1500. The audio cable 1590 transmits audio data to and from the multi-functional input device 1500. The data cable 1580 transmits data, which may include visual data, to and from the multi-functional input device 1500.

One of the ports 1560 may be configured to electrically connect the multi-functional input device 1500 to a power source for supplying electricity to the multi-functional input device 1500.

An embodiment of the system and method of processing audio data comprises, with a guitar-simulating video game controller capable of sending input signals using a protocol readable by a system capable of processing audio data: connecting to an external device or a system capable of processing audio data from the controller and processing the signals; and engaging the input mechanisms of the controller. An embodiment of the guitar-simulating video game controller used in this system and method further comprises additional and detachable attachment points between the input mechanisms and the processor of the controller.

An embodiment of the guitar-simulating video game controller used in this system and method includes a means for producing sound directly from the controller. The means for producing sound directly from the controller is accomplished by one or more speakers.

I claim:

1. A multi-functional input device, comprising:
(a) a body;
(b) one or more input mechanisms housed within the body and able to be engaged by a user;
(c) at least one processor housed within the body, the processor or processors being able to process input signals for use by either a video game console or a system capable of processing audio data;
(d) a means for connecting one or more input mechanisms to the processor;
(e) a means for connecting the processor to an external device remotely or by direct connection.

2. The input device of claim 1, further comprising a single processor capable of processing input signals for use by either a video game console or a system capable of processing audio data.

3. The input device of claim 1, wherein the processor or processors can detect the type of external program and process input signals accordingly.

4. The input device of claim 1, wherein the processor or processors can process and output signals in two or more data formats in a simultaneous or near-simultaneous manner.

5. The input device of claim 1, further comprising a second processor housed within the body and connected to one or more input mechanisms; the first processor being configured to process input signals for use either by a video game console or by a system capable of processing audio data but not both, and the second processor being configured to process input signals for use by either a video game console or by a system capable of processing audio data but not for the same purpose as the first processor.

6. The input device of claim 1, further comprising a means for producing sound directly from the input device, said means for producing sound being housed within the body.

7. The input device of claim 1, wherein the input device is a guitar-simulating video game controller.

8. The means for connecting input mechanisms to a processor as in claim 1, wherein the means include an additional and detachable attachment point between an input mechanism and the processor.

9. A multi-functional input device, comprising:
(a) a body, having the shape of a guitar body;
(b) a neck, being an elongated portion of the device connected to and extending outwardly from the body;
(c) a processor housed within the body, the processor being able to process input signals for use by an external program or device;
(d) one or more input mechanisms housed within the neck and able to be engaged by a user, the input mechanisms being attached to the processor by means other than soldering;
(e) one or more input mechanisms housed within the body and able to be engaged by a user, the input mechanisms being attached to the processor by means other than soldering;
(g) a means for connecting the processor to an external program or device remotely or by direct connection.

10. The input device of claim 9, further comprising a means for producing sound directly from the input device, said means for producing sound being housed within the body.

11. The means for connecting input mechanisms to a processor as in claim 9, wherein the means includes an additional and detachable attachment point between an input mechanism and the processor.

12. The input mechanisms housed within the neck as in claim 9, wherein the input mechanisms simulate guitar frets.

13. The input device of claim 9, further comprising a start/select button input mechanism housed within the body and detachably attached to the processor.

14. The input device of claim 9, further comprising a guitar strum-simulating button input mechanism housed within the body and detachably attached to the processor.

15. The input device of claim 9, further comprising a whammy input mechanism housed within the body and detachably attached to the processor.

16. The input device of claim 9, wherein the processor is capable of processing and outputting signals in two or more data formats in a simultaneous or near-simultaneous manner.

17. The input device of claim 9, further comprising a second processor housed within the body and connected to one or more input mechanisms, the first processor being configured to process input signals for use either by a video game console or by a system capable of processing audio data but not both, and the second processor being configured to process input signals for use by either a video game console or by a system capable of processing audio data but not for the same purpose as the first processor.

18. A system and method of processing audio data, comprising:
(a) with a guitar-simulating video game controller capable of sending input signals using a protocol readable by a system capable of processing audio data:
(i) connecting to an external device or a system capable of processing audio data from the controller and processing the signals
(ii) engaging the input mechanisms of the controller.

19. The guitar-simulating video game controller of claim 18, further comprising additional and detachable attachment points between the input mechanisms and processor.

20. The system and method of claim 18, wherein the guitar-simulating video game controller includes a means for producing sound directly from the controller.
